(19) United States
(12) Patent Application Publication
(10) Pub. No.: US 2010/0218386 A1
(43) Pub. Date: Sep. 2, 2010

(54) Battery Pack-Operated Hand-Held Power Tool

(75) Inventors: Heiko Roßkamp, Adelberg (DE); Harald Mang, Winnenden (DE); Matthias Müller, Remshalden (DE); Volker Reber, Michelbach (DE); Georg Heinzelmann, Backnang (DE)

Correspondence Address: GUDRUN E. HUCKETT DRAUDT, SCHUBERTSTR. 15A, WUPPERTAL, 42289, DE

(73) Assignee: ANDREAS STIHL AG & CO. KG, Waiblingen (DE)

(21) Appl. No.: 12/709,526

(22) Filed: Feb. 22, 2010

(30) Foreign Application Priority Data
Feb. 27, 2009 (DE) 10 2009 012 178.1

(51) Int. Cl. B26B 15/00; B26B 27/00

(52) U.S. Cl. 30/277.4; 30/312

(57) ABSTRACT

A hand-held power tool has a device housing having a battery pack compartment. An electric drive motor is arranged in the device housing. An output for driving a working tool is connected to the electric drive motor and arranged in the device housing. A battery pack is arranged in the battery pack compartment and is substantially received completely in the battery pack compartment. At least one grip for guiding the power tool is provided. The device housing has a housing volume and the battery pack compartment has a compartment volume located inside the device housing. A ratio of the housing volume to the compartment volume is approximately 1.5 to maximally io approximately 5.

### BACKGROUND OF THE INVENTION

The invention relates to a hand-held power tool, in particular a portable, hand-guided power tool such as a hedge trimmer, a motor chain saw, a grass or brush trimmer, or the like, comprising a device housing with an electric drive motor and an output for a working tool arranged therein. A battery pack is connected to the device housing, and a grip for guiding the power tool is provided on the device housing.

U.S. 2007/0240892 A1 discloses a hand-held power tool configured as a motor chain saw, having a device housing in which an electric drive motor with a correlated output for a working tool, a saw chain, is arranged. A battery pack is connected or docked from the exterior to the contour of the device housing. The operator guides the power tool by gripping with one hand a first rear grip provided with an operating element that controls the drive motor; a second front grip is gripped by the other hand of the operator in order to hold the power tool.

Such two-hand power tools are known in various embodiments. The configuration of such devices with a battery pack-operated electric motor constitutes a special problem because, on the one hand, a satisfactory drive power must be made available and, on the other hand, a satisfactory operating time is required. The electric power that is to be made available requires appropriate large and heavy battery packs independent of the chemical build of the battery cells.

Such battery packs are usually connected or docked on the exterior of the device housing and therefore project significantly from the contour of the device housing. The greater the desired machine power and the desired operating time, the greater the battery pack and the more it projects from the device housing.

### SUMMARY OF THE INVENTION

It is an object of the present invention to configure a battery pack operated power tool such that, while providing a satisfactory power and operating time, a device configuration is possible that enables a compact device housing without any disturbing attachments.

In accordance with the present invention, this is achieved in that the battery pack is substantially received completely in a compartment within the device housing, wherein the device housing has a housing volume and the compartment has a compartment volume located inside the device housing, wherein a ratio of the housing volume to the compartment volume is in a range of approximately 1.5 to maximally approximately 5.

The battery pack is received substantially with its entire length completely in the compartment of the device housing. The volume ratio according to the present invention makes available, on the one hand, a sufficiently large compartment volume for a battery pack of an appropriately selected size and ensures, on the other hand, enough space within the device housing in order to arrange device components such as a drive motor, an output, and the like in a space-saving and expedient way inside the device housing.

The volume ratio V of the housing volume relative to the compartment volume can be lowered expediently to below 2.5 so that a compact versatile power tool is provided.

Not only the adjustment of the volumes relative to one another is important but also the position of the center of gravity of the battery pack within the device housing. Advantageously, the arrangement is selected such that a ratio of the length of the power tool, measured from the rear grip to a front end face of the power tool, to the distance of the center of mass of the battery pack from the rear grip is approximately 1.7 to 2.8, in particular approximately 2. Advantageously, in this connection a height position is selected such that a ratio of the height of the device housing of the power tool, measured from the bottom of the power tool, to the distance of the center of mass of the battery pack from the bottom is approximately 1.5 to 2.5, in particular approximately 1.8.

It has been found to be expedient that in a plan view onto the power tool the center of mass of the battery pack is positioned at a preferably minimal lateral spacing relative to the longitudinal axis of the power tool.

The battery pack has a volume of approximately 500 cm³ up to 1,200 cm³ and in particular approximately 1,100 cm³. In this way, it provides sufficient space for a combination of individual battery cells arranged in the battery pack housing, no matter whether NiCd cells (nickel cadmium cells), NiMH cell (nickel metal hydride cells), LiIo cells (lithium ion cells), LiPo cells (lithium polymer cells), LiFePO4 cells (lithium iron phosphate cells), lithium titanate cells or cells of a similar build are used.

Advantageously, the battery cell voltage is in the range of 2 volts to 5 volts, preferably 3.6 colts to 3.7 volts, wherein, depending on the number of battery cells and the type of connection (serial connection, parallel connection), battery pack voltages of 12 volts to 80 volts, preferably, 25 volts to 51 volts, can be provided. Advantageously, the battery pack has an off-load voltage of 36 to 48 volts.

The housing volume comprises the compartment volume of the compartment and, in particular, also the volume of a rear grip that is expediently embodied as a monolithic part of the device housing and is incorporated into the housing volume.

The battery pack has an approximately parallelepipedal geometry and extends with its longitudinal axis approximately across the entire height of the device housing. The battery pack is arranged between the rear grip and the front grip of the power tool wherein the longitudinal axis of the battery pack compartment is expediently positioned relative to the longitudinal axis of the power tool at an angle of less than 90°. Advantageously, the longitudinal axis of the compartment relative to a vertical line relative to the bottom of the device housing may be tilted to the front or to the rear at an angle in a range of approximately 2° to 20°, in particular about 10° to 15°.

The drive motor and particularly also the output are positioned in the area between the compartment, and the battery pack arranged therein, and the front end face of the device housing. In this connection, the drive motor is expediently positioned approximately below the front grip wherein the axis of rotation of the drive motor is positioned transversely to the longitudinal axis of the device housing and is positioned relative thereto, particularly at an angle of 90°. The term transversely to the longitudinal axis of the power tool is to be understood to mean a horizontally positioned axis of rotation of the drive motor (in case of a motor chainsaw) as well as a vertically positioned axis of rotation of the drive motor (hedge trimmer).

The drive motor can be a brush motor as well as a DC motor that is operated by means of an electronic control. In a preferred embodiment of the invention an EC (electronically commutated) motor, or brushless motor, with an exterior rotor is provided that is operated by means of an appropriate electronic control. The electronic control is advantageously arranged in the area of the front grip in the device housing.

### BRIEF DESCRIPTION OF THE DRAWING

FIG. 1 is a schematic illustration in a view from above of a motor chain saw that is held by an operator.

FIG. 2 is a schematic side view of the motor chainsaw according to FIG. 1.

FIG. 3 is schematic plan view of the motor chainsaw according to FIG. 1.

FIG. 4 is a schematic side view of a hedge trimmer.

FIG. 5 is a schematic plan view onto a hedge trimmer according to FIG. 4.

### DESCRIPTION OF THE PREFERRED EMBODIMENTS

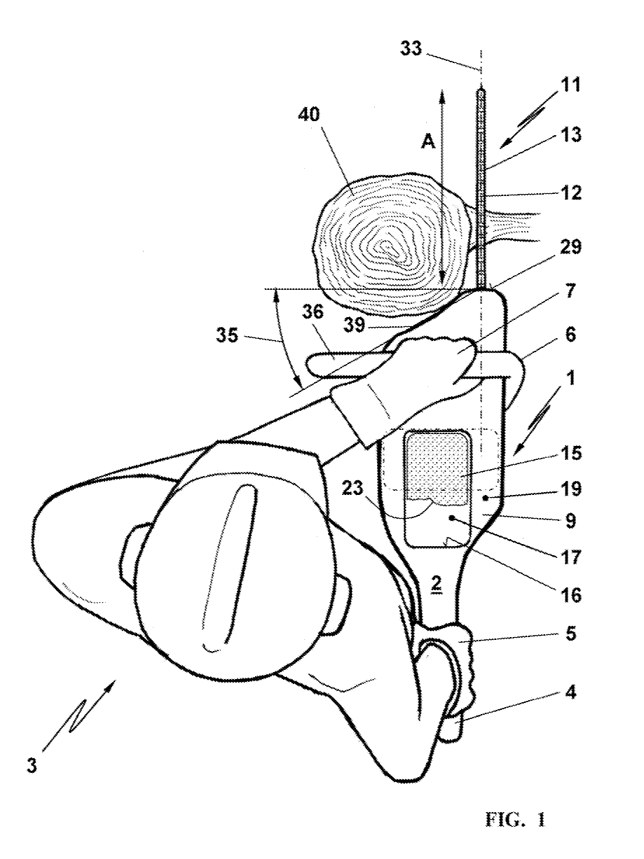

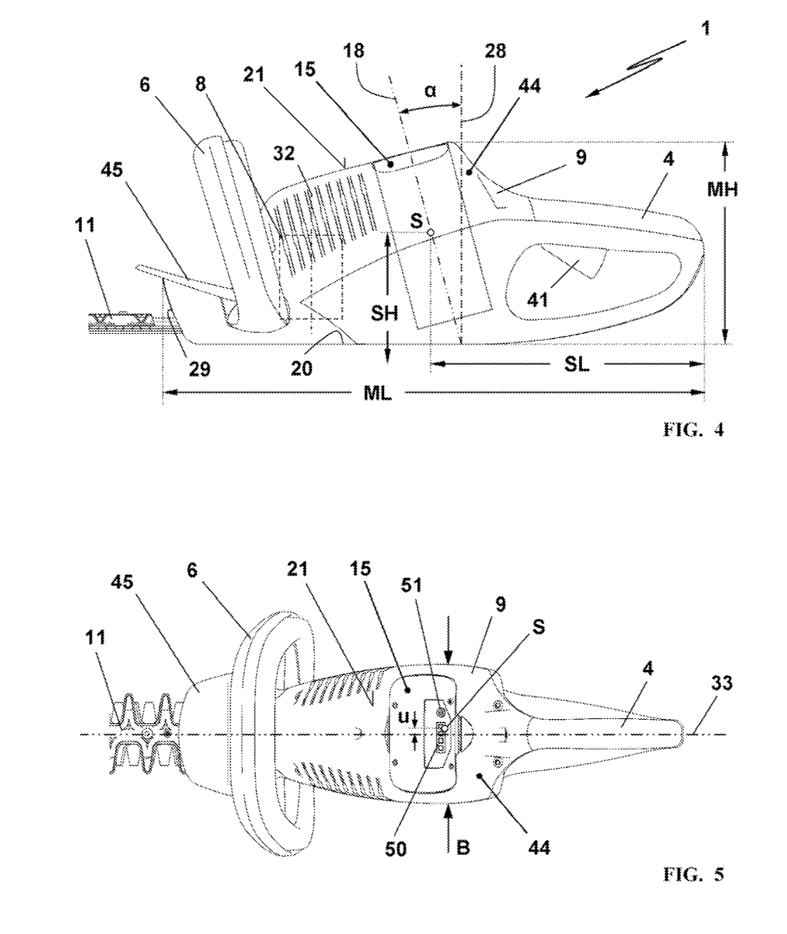

The embodiment of a hand-held power tool 1 illustrated in FIGS. 1 through 3 is a motor chain saw 2 that is carried and guided by operator 3. The hand-held power tool 1 according to the invention can also be a hedge trimmer, as illustrated in FIGS. 4 and 5, but also a cut-off machine, a brush or grass trimmer, an edger, a pole pruner, a blower, a sprayer, a vacuuming device, an earth auger, a multi-task motor device for multi-functional attachments, a sweeper, a rotary hoe, a rototiller (cultivator), a high-pressure cleaning device, a lawnmower, a dethatcher, a chopper or shredder, a wet/dry vacuum cleaner or a similar power tool.

The operator 3 guides the power tool 1 illustrated in the drawings by means of two grips wherein a first rear grip 4 is gripped by one hand 5 of the operator and the second front grip 6 is gripped by the other hand 7 of the operator 3. The illustrated hand-held power tool is thus a two-hand device with a rear grip 4 and a front grip 6. The rear grip 4 is preferably embodied as a monolithic part together with the device housing 9 and is comprised particularly of joined grip shells. The front grip 6 is embodied as a bow grip that extends transversely to the longitudinal axis 33 of the power tool. The rear grip 4 is aligned in the direction of the longitudinal axis 33.

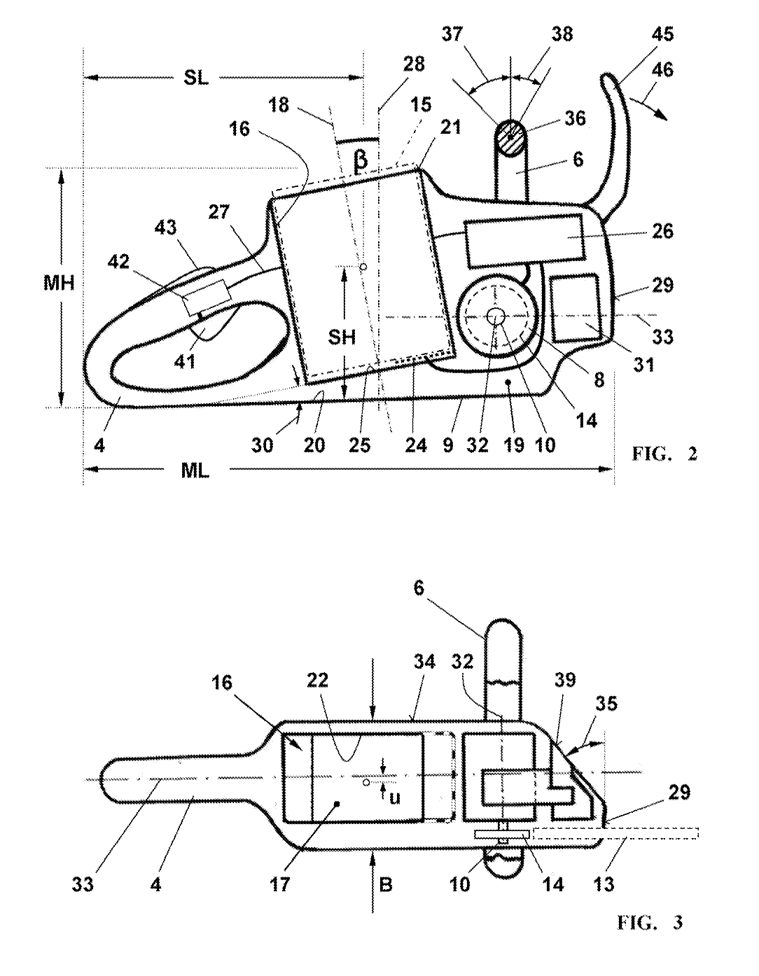

The device housing 9 of the power tool 1 delimits a device volume 19. The device volume 19 is the space volume that is enclosed by the housing parts of the device housing 9 that are preferably comprised of plastic material. The device volume 19 does not include the cutting or working tool 11 of the power tool 1. As shown in FIGS. 2 and 3, in the device housing 9 an electrical drive motor 8 as well as an output 10 for the working tool 11 are received. In the embodiment according to FIGS. 1 through 3, the working tool 11 is a saw chain 12 that circulates in an exterior circumferential groove of a guide bar 13. The saw chain 12 is driven by a chain pinion 14 that is drivingly connected to the output 10, in the embodiment a motor shaft.

The device housing 9 of the power tool 1 is connected to a battery pack 15. In the illustrated embodiment the battery pack 15 is received and housed in a compartment 16 that is provided within the device housing 9. The compartment 16 has a compartment volume 17 that substantially matches the volume of the battery pack 15 and is preferably slightly greater. The arrangement is such that the battery pack 15, as illustrated in FIG. 2 in dashed lines, is substantially completely received in the compartment 16 of the device housing 9. The battery pack has expediently a volume of approximately 500 cm³ to 1,200 cm³, in particular approximately 1,100 cm³.

The housing volume 19 and the compartment volume 17 of the compartment 16 have a ratio V relative to one another; according to the present invention, the ratio V of the housing volume 19 to the compartment volume 17 is in a range of approximately 1.5 to maximally approximately 5. In a special embodiment, the ratio is selected such that it is smaller than 2.5.

As can be seen in FIG. 2 in connection with FIG. 3, the battery pack 15 has a substantially parallelepipedal shape wherein it extends with its longitudinal extension (length) in the longitudinal axis 18 approximately across the entire height H of the device housing 9. In accordance with this, the compartment 16 extends approximately from the device bottom 20 to the device top 21 of the device housing 8 wherein the compartment 16 at the end that is facing the device top 21 is open and forms an insertion opening 22 through which the battery pack 15 is inserted into the compartment 16 and thus into the device housing 9.

The battery pack 15 is comprised of a plurality of individual battery cells arranged in the battery pack housing 23; for example, the cells are NiCd cells (nickel cadmium cells), NiMH cells (nickel metal hydride cells), Li-ion cells (lithium ion cells), LiPo cells (lithium polymer cells), LiFePO4 cells (lithium iron phosphate cells), lithium titanate cells or cells of a similar chemical build. The cell voltage of an individual cell is in the range of 2 volts to 5 volts, preferably approximately 3.6 volts to 3.7 volts. With such battery cells, depending on the type of connection (serial connection, parallel connection), battery pack voltages of 12 volts to 80 volts, preferably, 25 volts to 51 volts, can be made available.

The block of battery cells that is wired within the battery pack housing 23 is electrically contacted by an external contact plate 24 wherein the contact plate 24 is provided at the bottom 25 of the compartment 16. The contact plate 24 is thus positioned remote from the insertion opening 22 so that upon insertion of the battery pack 15 in the direction of its longitudinal axis 18 electric contacting of the battery pack 15 in the end section of the insertion path is realized. The contact plate 24 is connected to electronic control 26 to which is connected the electric drive motor 8. The electronic control 26 converts control signals received through a control line 27, controls the drive motor 8 accordingly, and supplies the motor 8 appropriately with current from the battery pack 15.

The electric drive motor has an electric power rating of more than 100 watts, preferably in a range of 500 watts to 5,000 and can be embodied either as an EC (electronically commutated) motor, or brushless motor, or embodied as a DC motor, or brushed motor. The control of the drive motor is realized by means of electronic control 26 with direct current (DC), preferably pulse width-modulated direct current. The electronic control 26 of the power tool may also comprise the electronic control circuit for a brushless EC motor.

According to structural requirements of the illustrated power tool 1 the battery pack 15 is positioned in the device housing 9 between the front grip 6 and the rear grip 4. While the front grip 6 is mounted as an attachment part on the device housing 9, the rear grip 4 is a monolithic part integrated in the device housing 9. According to the definition of the present invention, the volume of the rear grip 4 is a part of the housing volume.

In accordance with the definition of the present invention, the volume 17 of the compartment 16 is also part of the housing volume. The compartment 16 is tilted relative to a vertical line relative to the housing bottom 20 of the device housing 9. As a result of this tilted arrangement, the bottom plate 25 of the compartment 16 is positioned relative to the bottom 20 of the device housing 9 at an angle 30 that is in the range of approximately 4° to 20°. The angle 30 opens toward the front end face 29 of the device, housing 9. As a result of this design, the longitudinal axis 18 of the compartment 16 or of the battery pack 15 is tilted toward the rear grip 4, i.e., is tilted toward the rear of the power tool, and is positioned relative to the vertical line 28 relative to the bottom 20 of the device housing 9 at an angle β that is between 4° and 20°, in particular approximately 10°. Because of the slanted position of the battery pack 15 the rear grip 4 may be positioned closer to the device housing 9 so that a short length L of the device housing 9 results. When the battery pack 15, as illustrated in dashed lines in FIG. 1, is mounted in such a way that its minimal extension is in the direction of the longitudinal axis 33 of the power tool, the length ML can be further reduced. In case of a motor chain saw, a short leverage is provided in this way so that the feeding force that is applied by the operator cannot become too large and the blocking tendency of the cutting tool during cutting action is reduced.

The electric drive motor 8 with the output 10 is positioned in the power tool according to the invention between the compartment 16, and thus the battery pack 15 arranged therein, and the front end face 29 of the device housing 9. Advantageously, the drive motor 8 is positioned approximately below the front grip 6 wherein the electronic control 26 for the drive motor 8 is also received in the area of the front grip 6 in the device housing 9. In the embodiment according to FIGS. 1 to 3, a lubricant tank 31 for chain oil is moreover provided. The chain oil is conveyed into the circumferential groove of the guide bar 13 in order to reduce friction between the guide bar 13 and the saw chain 12 circulating thereon.

The axis of rotation 32 of the drive motor 8 is positioned transversely to the longitudinal axis 33 of the power tool, wherein the drive motor 8 may be mounted as shown in FIG. 3 with the horizontal axis of rotation 32 (motor chain saw) but also, as shown in FIGS. 4 and 5, with the axis of rotation 32 upright relative to the bottom 20 of the device housing 9 (hedge trimmer). In both cases, the axis of rotation 32 of the drive motor 8 is positioned transversely to the longitudinal axis 33 of the power tool, in particular at an angle of 90° relative to the longitudinal axis 33.

As illustrated in the embodiments, the drive motor 8 is positioned approximately below the upper grip section 36 of the front grip 6 that is embodied as a so-called bow grip. This means that the front grip 6 with one end is secured in the area of the housing bottom 20, extends from here across one longitudinal side, then transversely to the longitudinal axis 33 of the power tool across the housing top 21 of the device housing 9, and then downward along the other longitudinal side 34 at a spacing thereto and is then secured in the area of the housing bottom 20 of the device housing 9.

A hand guard 45 is arranged in front of the front grip 6 and, in case of a motor chain saw 2, may serve to trigger a safety brake that is known in the art. When triggering the safety brake by pivoting the hand guard in the direction of arrow 46 (FIG. 2), the chain pinion 14 is stopped by an appropriately designed braking device so that the saw chain 12 with triggered safety brake device will be stopped within fractions of a second.

The drive motor 8, the electronic control 26, and in case of a motor chain saw, the lubricant tank 31 are arranged in the area of the front grip 6 in the device housing 9 such that the front end face 29 comprises a slanted surface 39 passing into the longitudinal side 34. As shown in FIG. 1, the slanted surface 39 is positioned at an angle 35 relative to a plane of the front end face 29 wherein the angle 35 is in a range of approximately 10° to 40°, in particular is 30°.

By employing an EC motor with exterior rotor not only a high power output can be provided but also the constructive width B (FIG. 3) of the power tool 1 can be kept small. The width B of the power tool 1 is preferably smaller than 125 mm.

The reduced width B and the short length ML in combination with the slanted surface 39 arranged at the front end face 29 leads to easy handling of the power tool 1 that can be employed by the operator 3 in a simple and expedient way. As shown in FIG. 1, in case of a motor chain saw 2, it is possible to work dose to a tree trunk 40 for cutting off branches as a result of the slanted surface 39 so that the working length of the guide bar 13 can be kept small. Working lengths of the guide bar between 15 cm and 35 cm are sufficient.

The size of the power tool 1 (FIGS. 1 through 5) in combination with positioning of the component assemblies (drive motor 8 with output 10, electronic control 26, battery pack 15) provide for a balanced power tool in such a way that, when holding the power tool 1 at the upper grip section 36, the longitudinal axis 33 of the power tool pivots relative to the horizontal about an angle 37 of approximately −30° or an angle 38 of approximately +15°. Despite the battery pack 15 that contributes greatly to the weight of the power tool, because of the battery pack arrangement as well as the positioning of the other component assemblies a balanced power tool is provided that enables a comfortable carrying action of the power tool at the upper grip section 36 of the front grip 6. A balanced range of approximately 45° is provided.

For starting up the hand-held power tool according to the invention the operator grips the grips 4 and 6 as illustrated in FIG. 1. With the rear hand 5 a control lever 41 is actuated that acts on an electronic actuator 42 such as a microswitch or the like. The microswitch 42 is connected by means of the control line 27 to the electronic control 26.

It can be expedient to block the control lever 41 by means of a lever lock 43 (FIG. 2) that is arranged on the side of the grip 4 opposite the control lever 41. When gripping the rear grip 4 the operator will suppress by means of the palm of his hand the lever lock 43 so that the control lever 41 may be actuated by the fingers of the operator. Advantageously, the control lever 41 is embodied like a throttle lever, i.e., depending on the position of the control lever 41 the engine speed of the drive motor 8 is controlled by means of the electronic control 26.

The signals that are provided by control line 27 to the electronic control 26 are processed therein and then the drive motor 8 is operated in accordance therewith. This is done expediently by means of a cycled direct current signal whose signal width is variable.

The power tool 1 illustrated in FIGS. 4 and 5 is a hedge trimmer 44 whose schematic configuration corresponds to that of the power tool 1 according to FIGS. 1 to 3. Same parts are therefore identified with same reference numerals.

As a working tool 11 on the device housing 9 a cutter bar is attached whose cutter blades are reciprocatingly driven by a gear of the drive motor 8. From the rearward end of the rear grip 4 to the front end face 29, i.e., without taking into account the working tool 11, the hedge trimmer 44 as well as the motor chain saw 2 according to FIGS. 1 to 3 have a total length ML that is in the range of 350 mm to 500 mm, in particular 390 mm to 470 mm. The housing width B of the illustrated power tool 1 is in the range of 120 mm to 180 mm, preferably in the range of 135 mm to 150 mm.

The center of gravity of the battery pack 15 inserted into the device housing 9 has a height position at a spacing SH above the housing bottom 25 in the range of approximately 80 mm to 110 mm, preferably 90 mm to 100 mm. In the embodiment according to FIG. 2, the spacing SH is approximately 98 mm, in the embodiment according to FIG. 4 approximately 93 mm.

The arrangement of the battery pack 15 in the device housing 9 is selected such that the length ML of the power tool 1 from the rearward end of the rear grip 4 to the front end face 29 and the spacing SL of the center of mass S of the battery pack 15 from the rearward end of the rear grip 4 have a ratio ML/SL relative to one another of approximately 1.7 to 2.8, in particular of approximately 2. The housing height MH of the device housing 9 measured relative the housing bottom 20 of the power tool 1 and the spacing SH of the center of mass S of the battery pack 15 from the bottom 20 have a ratio MH/SH relative to one another of approximately 1.5 to 2.5, in particular of approximately 1.8. In the lateral position according to the plan view in accordance with FIG. 3 or FIG. 5, the center of mass S of the battery pack 15 is positioned at a preferably minimal lateral spacing u relative to the longitudinal axis 33 extending through the rear grip 4.

As shown in FIG. 4, the battery pack 15 relative to a perpendicular 28 relative to the bottom 25 of the device housing 9 is tilted forward. The angle a between the longitudinal axis 18 of the battery pack 15 and the vertical line 18 is in a range of 2° to 20°; in particular the angle a is approximately 15°.

As shown in the plan view onto the battery pack 15 according to FIG. 5, in the end face of the battery pack that is positioned at the housing top 21 of the device housing 9 display elements 50 for visualizing a battery pack charge state or the like are provided. By means of an actuating element 51 arranged at the end face it is possible to retrieve operating data of the battery pack 15 or to initiate testing cycles.

The specification incorporates by reference the entire disclosure of German priority document 10 2009 012 178.1 having a filing date of Feb. 27, 2009.

While specific embodiments of the invention have been shown and described in detail to illustrate the inventive principles, it will be understood that the invention may be embodied otherwise without departing from such principles.

What is claimed is:

1. A hand-held power tool comprising:
a device housing having an interior with a battery pack compartment;
an electric drive motor arranged in said device housing;
an output, connected to said electric drive motor and arranged in said device housing, for driving a working tool;
a battery pack arranged in said battery pack compartment and substantially received completely in said battery pack compartment;
at least one grip for guiding the power tool;
wherein said device housing has a housing volume and said battery pack compartment has a compartment volume located inside said device housing;
wherein a ratio of said housing volume to said compartment volume is approximately 1.5 to maximally approximately 5.

2. The power tool according to claim 1, wherein said ratio is smaller than 2.5.

3. The power tool according to claim 1, wherein a ratio of a length of the power tool, measured from said at least one grip that is arranged at a rear of said device housing to a front end face of said device housing, to a spacing of a center of mass of said battery pack from said at least one grip is approximately 1.7 to 2.8.

4. The power tool according to claim 3, wherein said ratio is approximately 2.

5. The power tool according to claim 1, wherein a ratio of a housing height of said device housing measured relative to a bottom of the power tool and a spacing of a center of mass of said battery pack from said bottom is approximately 1.5 to 2.5.

6. The power tool according to claim 5, wherein said ratio is approximately 1.8.

7. The power tool according to claim 1, wherein a center of mass of said battery pack is positioned laterally spaced relative to a longitudinal axis of the power tool.

8. The power tool according to claim 1, wherein said battery pack has a volume of approximately 500 cm³ to 1,200 cm³.

9. The power tool according to claim 8, wherein said volume of said battery pack is approximately 1,100 cm³.

10. The power tool according to claim 1, wherein said battery pack has a nominal voltage of approximately 12 volts to 80 volts.

11. The power tool according to claim 10, wherein said nominal voltage of said battery pack is approximately 25 volts to 51 volts.

12. The power tool according to claim 1, wherein said compartment volume is part of said housing volume.

13. The power tool according to claim 1, wherein said at least one grip is an integral rear grip of said device housing and constitutes a portion of said housing volume.

14. The power tool according to claim 1, wherein said battery pack has a substantially parallelepipedal geometry with a longitudinal extension that extends approximately across an entire height of said device housing.

15. The power tool according to claim 1, wherein said at least one grip is an integral rear grip of said device housing and wherein a front grip is connected to said device housing, wherein said battery pack is disposed between sad rear grip and said front grip.

16. The power tool according to claim 15, wherein said electric drive motor and said output are arranged in said device housing in an area between said battery pack compartment and a front end face of said device housing.

17. The power tool according to claim 16, wherein said electric drive motor is positioned approximately below an upper grip section of said front grip.

18. The power tool according to claim 1, wherein a longitudinal axis of said battery pack compartment is positioned relative to a longitudinal axis of said device housing at an angle that is smaller than 90°.

19. The power tool according to claim 18, wherein said longitudinal axis of said battery pack compartment relative to a perpendicular onto a bottom of said device housing is tilted to the front or to the rear of said device housing by an angle in a range of approximately 2° to 20°.

20. The power tool according to claim 19, wherein said angle is 10° to 15°.

21. The power tool according to claim 1, wherein an axis of rotation of said electric drive motor is positioned transverse to a longitudinal axis of the power tool.

22. The power tool according to claim 21, wherein said axis of rotation is positioned at an angle of 90° relative to said longitudinal axis of the power tool.

23. The power tool according to claim 1, wherein said at least one grip is a front grip connected to said device housing, wherein said electric drive motor is an EC motor comprising an electronic control, wherein said electronic control is arranged in an area of said front grip in said device housing.

24. The power tool according to claim 1, wherein a front end face of said device housing has a rearwardly slanted surface that is positioned relative to a longitudinal axis of said device housing at an angle of 10° to 40°.

25. The power tool according to claim 1, wherein a center of gravity of the power tool with the working tool is positioned in an area of said at least one grip embodied as a front grip in such a way that, when lifting the power tool by gripping an upper grip section of said front grip, said device housing pivots in a pivot range of +15° to −30° about said upper grip section.
